(19) United States
(12) Patent Application Publication
(10) Pub. No.: US 2024/0119231 A1
(43) Pub. Date: Apr. 11, 2024

(54) STORAGE MEDIUM, INFORMATION PROCESSING APPARATUS, AND CONTROL METHOD

(71) Applicant: CANON KABUSHIKI KAISHA, Tokyo (JP)

(72) Inventor: YURI UEDA, Tokyo (JP)

(21) Appl. No.: 18/480,391

(22) Filed: Oct. 3, 2023

(30) Foreign Application Priority Data
Oct. 5, 2022 (JP) 2022-160960

(51) Int. Cl. G06F 40/186; G06F 40/106

(52) U.S. Cl. CPC G06F 40/186; G06F 40/106; G06F 3/04842

(57) ABSTRACT

An information processing apparatus to execute managing template data for content data to be generated, accepting an input of information with respect to the content data, replacing information included in the template data with the information accepted, and generating the content data based on the information accepted, wherein, in a case where the template data includes information that is not replaced, the content data in a state where the information that is not replaced is not displayed is generated.

### BACKGROUND OF THE DISCLOSURE

### Field of the Disclosure

The present disclosure relates to a storage medium, an information processing apparatus, and a control method.

### Description of the Related Art

There has been known a technique which allows a user to produce data of content, such as a poster, by applying characters and image data to a template with a layout set in advance.

Japanese Patent No. 6800503 discusses a technique which allows a user to set attribute information corresponding to information about printing of customer data and create print data which includes a value of the attribute information.

However, the technique discussed in Japanese Patent No. 6800503 does not describe processing with respect to characters and images whose attribute information is not set.

### SUMMARY OF THE DISCLOSURE

The present disclosure is directed to improving convenience of production of contents data.

According to an aspect of the present disclosure, a non-transitory computer-readable storage medium stores a program for causing a computer to execute a control method of an information processing apparatus including managing template data for content data to be generated, accepting an input of information with respect to the content data, replacing information included in the template data with the information accepted, and generating the content data based on the information accepted, wherein, in a case where the template data includes information that is not replaced, the content data in a state where the information that is not replaced is not displayed is generated.

Further features of the present disclosure will become apparent from the following description of exemplary embodiments with reference to the attached drawings.

### BRIEF DESCRIPTION OF THE DRAWINGS

FIG. 1 is a diagram illustrating a configuration of an information processing apparatus according to a present exemplary embodiment.

FIG. 2 is a diagram illustrating a configuration of a system for implementing the present exemplary embodiment.

FIGS. 3A and 3B are diagrams illustrating an example of a layout of a screen having a data input function of an auto-design function.

FIG. 4 is a diagram illustrating an example of a layout of a screen on which poster data is displayed.

FIGS. 5A and 5B are diagrams illustrating examples of poster data.

FIG. 6 is a diagram illustrating an example of a layout of a screen of a selection dialogue.

FIG. 7 is a diagram illustrating an example of the layout of the screen on which the poster data is displayed.

FIG. 8 is a diagram illustrating an example of the poster data.

FIG. 9 is a flowchart relating to an auto-design function.

FIG. 10 is a flowchart relating to the auto-design function.

FIG. 11 is a diagram illustrating an example of a layout of a screen of a selection dialogue.

FIG. 12 is a diagram illustrating an example of a layout of the screen on which the poster data is displayed.

FIG. 13 is a diagram illustrating an example of the poster data.

FIG. 14 is a flowchart relating to the auto-design function.

FIG. 15 is a diagram illustrating an example of an edit screen for editing the poster data.

FIG. 16 is a diagram illustrating an example of the edit screen for editing the poster data.

### DESCRIPTION OF THE EMBODIMENTS

Hereinafter, the present disclosure will be described in detail with reference to the appended drawings. Exemplary embodiments described hereinafter are not intended to limit the present disclosure described in the appended claims, and not all of the combinations of features described in the exemplary embodiments are always essential to a solution of the present disclosure. Further, in the appended drawings, constituent elements identical or similar to each other will be designated by the same reference numeral, and duplicative descriptions thereof will be omitted.

### <System Configuration>

An information processing apparatus 100 to which the present disclosure is applied will be described. Although a personal computer (PC) is used as an example of the information processing apparatus 100, the present disclosure is applicable to any apparatus capable of displaying and editing text and in which a program is operable. For example, the present disclosure is also applicable to a mobile terminal, a laptop PC, a tablet terminal, and a personal digital assistant (PDA).

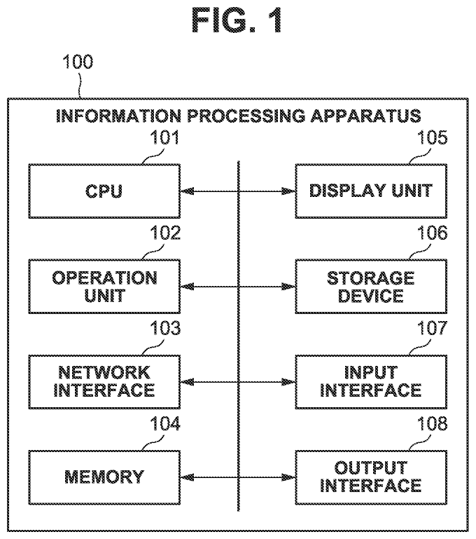

FIG. 1 is a diagram illustrating a hardware configuration of the information processing apparatus 100 according to a first exemplary embodiment. The information processing apparatus 100 includes a central processing unit (CPU) 101, an operation unit 102, a network interface 103, a memory 104, a display unit 105, a storage device 106, an input interface 107, and an output interface 108, which are connected to each other via a system bus.

The CPU 101 executes overall control of the information processing apparatus 100.

The operation unit 102 is an operation unit which includes a button and a touch panel and on which a user can input an instruction to the information processing apparatus 100. While FIG. 1 illustrates an example in which the operation unit 102 is built into the information processing apparatus 100, a configuration may be employed in which the user operates an external keyboard connected to the input interface 107 to input an instruction to the information processing apparatus 100.

The network interface 103 is an interface which enables the information processing apparatus 100 to connect to the network. The information processing apparatus 100 can connect to the network via the network interface 103, and can also connect to the Internet via the network.

The memory 104 is a random access memory (RAM) used as a work area of the CPU 101. The memory 104 is also used as a temporary storage area of various types of received data, and stores various types of setting data.

The display unit 105 is a unit which displays various types of information, and is a screen, such as a liquid crystal panel. While FIG. 1 illustrates an example in which the display unit 105 is built into the information processing apparatus 100, a configuration may be employed in which various types of information are displayed on an external display connected to the output interface 108.

The storage device 106 is, for example, a flash memory. The storage device 106 stores an application program, various types of control program such as an operating system (hereinafter, referred to as “OS”), and various types of information used for these programs.

The input interface 107 is an interface for accepting data and operation instructions input by the user. For example, the input interface 107 includes a physical keyboard, a button, and a touch panel.

The output interface 108 is an interface for executing control of displaying data and status information about the information processing apparatus 100 on an external display. For example, the output interface 108 outputs control information and information about a display target in order to display the information on the external display. The external display includes a light-emitting diode (LED), a liquid crystal display (LCD), or the like, and displays data and notifies the state of the information processing apparatus 100 to the user. In addition, a software keyboard which includes various keys, such as a numerical-value input key, a mode setting key, a determination key, a cancel key, and a power key, may be displayed on the external display, so that an input from the user can be accepted via the software keyboard. Further, the output interface 108 and the input interface 107 may be integrated so that output of a screen and acceptance of a user operation can be executed by common hardware.

### <Poster Production Application>

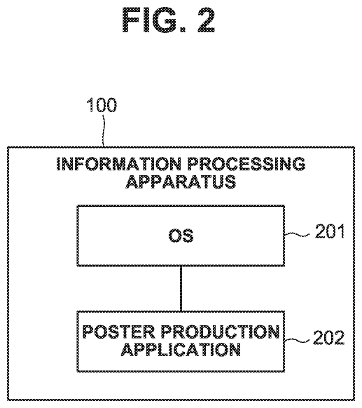

FIG. 2 is a diagram illustrating an example of a functional configuration of the information processing apparatus 100. As the functional configuration, for example, the information processing apparatus 100 includes an OS 201 and a poster production application 202 for executing the below-described processing. The user can produce data of content (in the present exemplary embodiment, a poster) via a screen displayed by the poster production application (program) 202. In the present exemplary embodiment, it is described that the content is a poster. However, the content is not limited to a poster. The content may be a document. Poster data 402 produced thereby is, for example, posted on a home page or a social networking service (SNS) or printed via a connection between a printing apparatus and the information processing apparatus 100. Further, in the present exemplary embodiment, while the poster production application 202 is included in the information processing apparatus 100, the poster production application 202 may be provided as a web application. Specifically, an external server may provide the poster production application 202 to the information processing apparatus 100, and the user can produce a poster by using the poster production application 202 on a web browser. In other words, a below-described screen, which is a screen displayed by the poster production application 202, may be displayed on a web browser. A configuration of the server is similar to the configuration of the information processing apparatus 100, i.e., the configuration illustrated in FIG. 1.

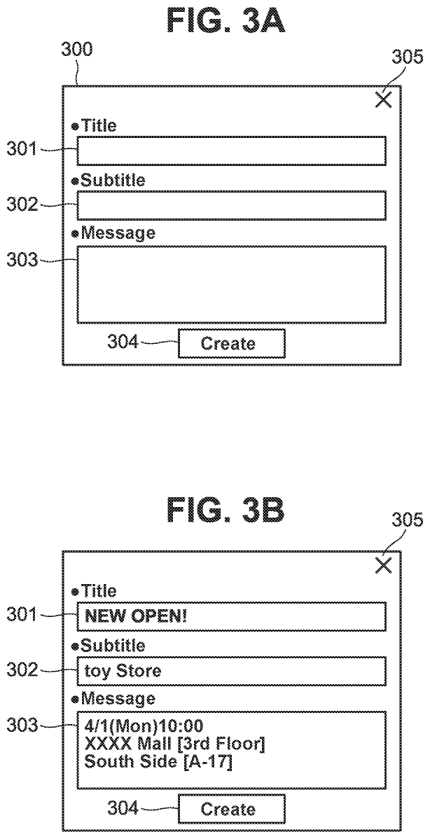

Next, an example of a production workflow implemented by the poster production application 202 will be described. FIGS. 3A and 3B illustrate an example of a poster production screen of the poster production application 202 displayed on the display unit 105 by the CPU 101 of the information processing apparatus 100 executing a program corresponding to the poster production application 202 stored in the memory 104 or the storage device 106.

FIG. 3A illustrates an example of a screen layout for accepting data input by the user of a function provided by the poster production application 202, such as a function (auto-design function) of automatically generating one piece or a plurality of pieces of appropriate poster data 402 based on input information and displaying the generated poster data 402 on the display unit 105. An input screen 300 includes a title character information input part 301, a subtitle character information input part 302, a message character information input part 303, a design generation execution button 304, and a close button 305.

Characters input by the user are respectively accepted by the title character information input part 301, the subtitle character information input part 302, and the message character information input part 303. FIG. 3B is a diagram illustrating an example of the input screen 300 when character information is input to the title character information input part 301, the subtitle character information input part 302, and the message character information input part 303.

When the user presses the design generation execution button 304, the poster production application 202 automatically generates one piece or a plurality of pieces of poster data 402 to which different types of design template data 501 are applied based on the content (input information) input to the title character information input part 301, the subtitle character information input part 302, and the message character information input part 303. In addition, the input screen 300 may also include an item for registering (inserting) image data.

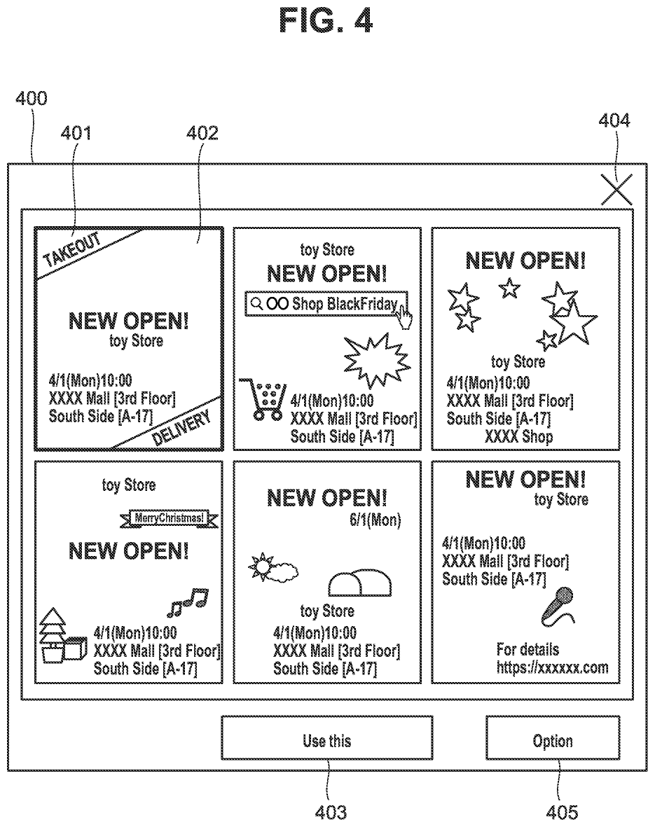

Specifically, the poster production application 202 holds and manages a plurality of design templates 501. A design template 501 is a form (i.e., template) with a design set in advance for poster data 402, and information about an arrangement (layout) of characters and images in a poster to be generated is held therein. The poster data 402 can easily be created by applying the information the user has input to the design template 501. The poster production application 202 manages respective arrangement conditions of the plurality of design templates 501. For example, the poster production application 202 manages the number of characters of the title, the number of characters of the subtitle, the number of characters of the message, and the number of images, which can be arranged in the design template 501. Then, in a case where the input performed by the user is accepted on the input screen 300, based on the input information, the poster production application 202 searches for a design template 501 having little difference in arrangement conditions from those of the input information, and extracts the design template 501. For example, the poster production application 202 compares the input information which the user has input to the title character information input part 301, the subtitle character information input part 302, and the message character information input part 303 with the information about the number of characters of the title, the number of characters of the subtitle, and the number of characters of the message, which can be arranged in the design template 501, and extracts one or a plurality of design templates 501 whose information about the numbers of characters is little different from the input information. Then, the poster production application 202 grades each of the extracted design templates 501, determines a display priority level based on the grading, and displays the design templates 501 on a result screen 400 (illustrated in FIG. 4) in order of higher priority. For example, a design template 501 whose arrangement condition is little different from the information input by the user can acquire a high score. Therefore, this design template 501 is determined as a design template of higher display priority. The poster production application 202 closes the input screen 300 when the user presses the close button 305 on the input screen 300.

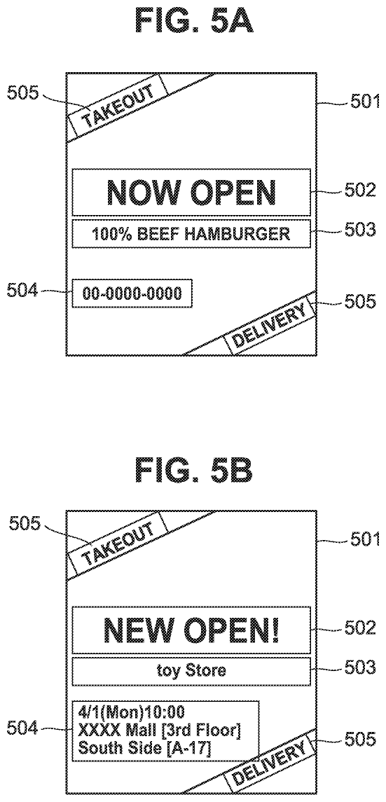

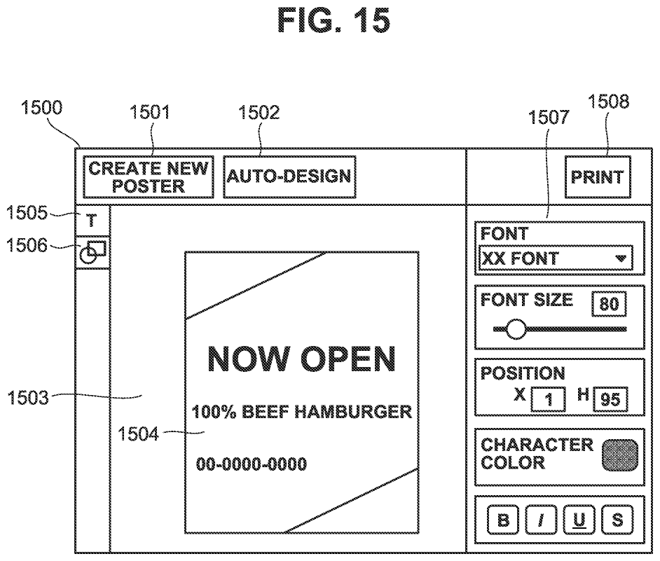

FIG. 4 is a diagram illustrating an example of a screen layout when one piece or a plurality of pieces of poster data 402 generated by the auto-design function that has been executed is displayed on the display unit 105. A result screen 400 includes a poster data display area 401, the poster data 402, a design determination button 403, and a close button 404. One piece or a plurality of pieces of poster data 402 to which different design templates 501 are applied is displayed on the poster data display area 401. Pieces of information respectively input to the title character information input part 301, the subtitle character information input part 302, and the message character information input part 303 of the input screen 300 are inserted into the predetermined design template 501, so that the poster data 402 is generated automatically. The poster data 402 is described below with reference to FIGS. 5A and 5B. The user can select one poster data 402 from the one piece or the plurality of pieces of poster data 402 displayed in the poster data display area 401. When the user selects any one of the poster data 402 displayed on the poster data display area 401 and presses the design determination button 403, the poster production application 202 displays an edit screen 1500, on which the selected poster data 402 can be edited as described below, of FIG. 15 on the display unit 105. Thus, the user can continuously edit the selected poster data 402 on the displayed edit screen 1500. Specific details of editing is described below with reference to FIG. 15. When the close button 404 is pressed, the poster production application 202 closes the result screen 400. Although it is described that the user is allowed to select one poster data 402 from among the one piece or the plurality of pieces of poster data 402 displayed in the poster data display area 401, the user may be allowed to select a plurality of pieces of poster data 402.

FIGS. 5A and 5B are diagrams illustrating examples of the poster data 402 displayed in the poster data display area 401 in FIG. 4. FIG. 5A illustrates poster data 402 to which a predetermined design template 501 is applied from among the plurality of design templates 501 previously held in the poster production application 202. A title, a subtitle, a message, and another character information 505, which are previously registered in the design template 501, are respectively displayed in a title character information area 502, a subtitle character information area 503, a message character information area 504, and an area of the character information 505. FIG. 5B illustrates poster data 402 which displays input information input to the title character information input part 301, the subtitle character information input part 302, and the message character information input part 303 of the input screen 300 in place of the information in the title character information area 502, the subtitle character information area 503, and the message character information area 504 of a design template 501, similar to the design template 501 in FIG. 5A. In FIG. 5B, because the character information 505 is not information corresponding to an area that is an input possible area of the input screen 300, information corresponding to the character information 505 is not input on the input screen 300. Thus, pieces of character information 505, “TAKE OUT” and “DELIVERY”, previously registered in the design template 501, are displayed. In a case where the poster production application 202 displays the poster data 402 automatically generated by executing the auto-design function in the poster data display area 401, the poster data 402 illustrated in FIG. 5B is displayed. In other words, in a case where the information input to at least one of the title character information input part 301, the subtitle character information input part 302, and the message character information input part 303 is accepted on the input screen 300, the poster production application 202 displays the poster data 402 of the design template 501, to which the input information input by the user is applied, on the poster data display area 401.

As described above, the character information 505 in FIG. 5B is information previously registered in a predetermined design template 501, and is not the information input by the user. When the user edits the poster data 402 generated by executing the auto-design function, the character information 505 can serve as a guide which helps the user input predetermined information to an area other than the areas corresponding to the title character information input part 301, the subtitle character information input part 302, and the message character information input part 303 of the input screen 300. Thus, the poster data 402 with the character information 505 displayed is displayed in the poster data display area 401. However, since the character information 505 is the information previously registered in a predetermined design template 501, there is a high possibility that the character information 505 is information less relevant to the pieces of input information the user has input to the title character information input part 301, the subtitle character information input part 302, and the message character information input part 303 of the input screen 300. More specifically, the poster data 402 is displayed on the result screen 400 in a state where the information input by the user on the input screen 300 and the character information 505 (hereinafter, called “predetermined character information”) which is previously registered in a predetermined design template 501 and less relevant to the information input by the user are intermingled. As a result, it may be difficult for the user to recognize an image of the poster once completed.

The same applies to a case where information is not input to the input possible area, such as the title character information input part 301, the subtitle character information input part 302, or the message character information input part 303 of the input screen 300. For example, in a case where information is not input to the subtitle character information input part 302 of the input screen 300, the characters to be displayed in the subtitle character information area 503 in FIG. 5B of the poster data 402 displayed in the poster data display area 401 are “100% BEEF HAMBURGER”, which is described in the subtitle character information area 503 in FIG. 5A. More specifically, the poster data 402 is displayed on the result screen 400 in a state where the information input by the user on the input screen 300 and the information which is previously registered in a predetermined design template 501 and less relevant to the information input by the user are intermingled.

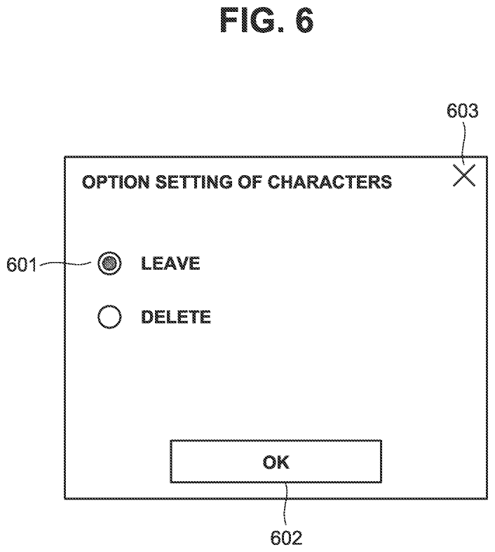

Thus, in the present exemplary embodiment, after the poster data 402 automatically generated by accepting an execution instruction of the auto-design function is displayed on the display unit 105, the poster production application 202 can accept a display instruction of a dialogue (e.g., a dialogue illustrated in FIG. 6) which prompts the user to select either to delete the predetermined character information from the automatically-generated poster data 402 or to leave and display the predetermined character information in the automatically-generated poster data 402. Then, when the display instruction of the dialogue is accepted, the poster production application 202 displays a dialogue, such as the dialogue illustrated in FIG. 6.

Then, in a case where an instruction for deleting the predetermined character information from the poster data 402 is input by the user and accepted on the displayed dialogue, the poster production application 202 generates poster data 402 from which the predetermined character information is deleted, and displays the poster data 402 on the result screen 400. Thus, the poster data 402 on which the predetermined character information, which is previously registered in the predetermined design template 501 and is less relevant to the information input by the user, is not displayed is provided to the user. Thus, the user can easily recognize the image of the poster once completed. While in the present exemplary embodiment, the predetermined character information is described as the character information 505 described above, the present exemplary embodiment is similarly applicable to the case where the information is not input to the input possible area, such as the subtitle character information input part 302 or the message character information input part 303 of the input screen 300.

FIG. 6 is a diagram illustrating an example of a dialogue which prompts the user to determine a processing method of the predetermined character information in the poster data 402. The dialogue is displayed on the display unit 105 when an option setting button 405 in FIG. 4 is pressed. A toggle button 601 has options “LEAVE” and “DELETE”. The option “LEAVE” is an option for executing the processing for displaying the poster data 402 in a state where the character information 505 previously registered in a predetermined design template 501 is included. When the automatically-generated poster data 402 is displayed on the result screen 400 for the first time, the poster data 402 with the character information 505 being displayed is displayed thereon. Thus, the toggle button 601 is displayed in a state where the option “LEAVE” is selected as an initial position. On the other hand, the option “DELETE” is an option for executing the processing for displaying the poster data 402 in a state where the character information 505 is deleted from the poster data 402 (i.e., the poster data 402 with the character information 505 not being displayed). Then, when an OK button 602 is pressed in a state where any one of the options is selected, the processing method of the character information 505 in the poster data 402 is determined, so that the poster data 402 automatically generated based on the determined method is displayed on the poster data display area 401 again. Further, the dialogue is closed when a close button 603 is pressed.

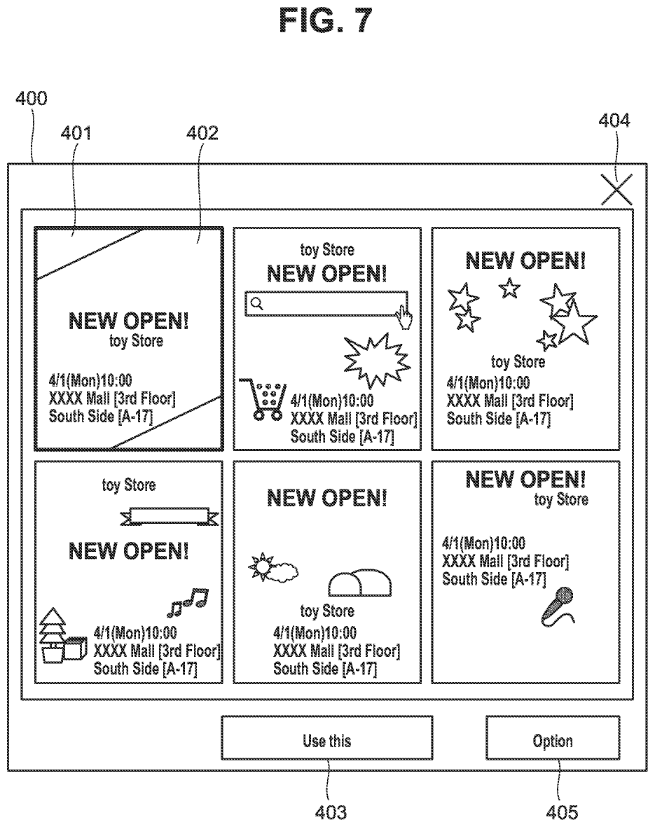

FIG. 7 is a diagram illustrating an example of the screen having the poster data display area 401 in which one piece or a plurality of pieces of automatically-generated poster data 402, from which the character information 505 is deleted, is displayed.

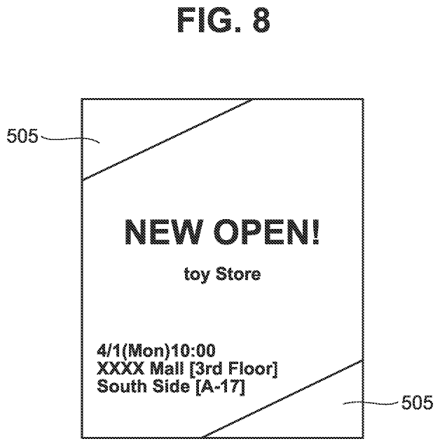

FIG. 8 is a diagram illustrating an example of the poster data 402 displayed in the poster data display area 401 in FIG. 7. A design template 501 similar to the design template 501 used for the poster data 402 in FIG. 5A is used for the poster data 402. FIG. 8 illustrates the poster data 402 in a state where deletion processing of the character information 505 is executed on the poster data 402 in FIG. 5B. Alternatively, the poster production application 202 may execute processing for hiding the character information 505 instead of executing the processing for deleting the character information 505, and any method for holding internal data may be employed as long as the processing makes it impossible for the user to visually recognize the character information 505. Further, the poster production application 202 may be configured to remove the character information 505 from printing targets when the poster data 402 is printed, instead of executing the deletion processing or the hiding processing of the character information 505. In other words, when the automatically-generated poster data 402 is displayed on the poster data display area 401, the character information 505 is displayed as illustrated in FIG. 4. However, a configuration may be employed where, when printing processing is executed on the poster data 402 selected from the poster data display area 401, the character information 505 is not printed on a printed material generated from that poster data 402.

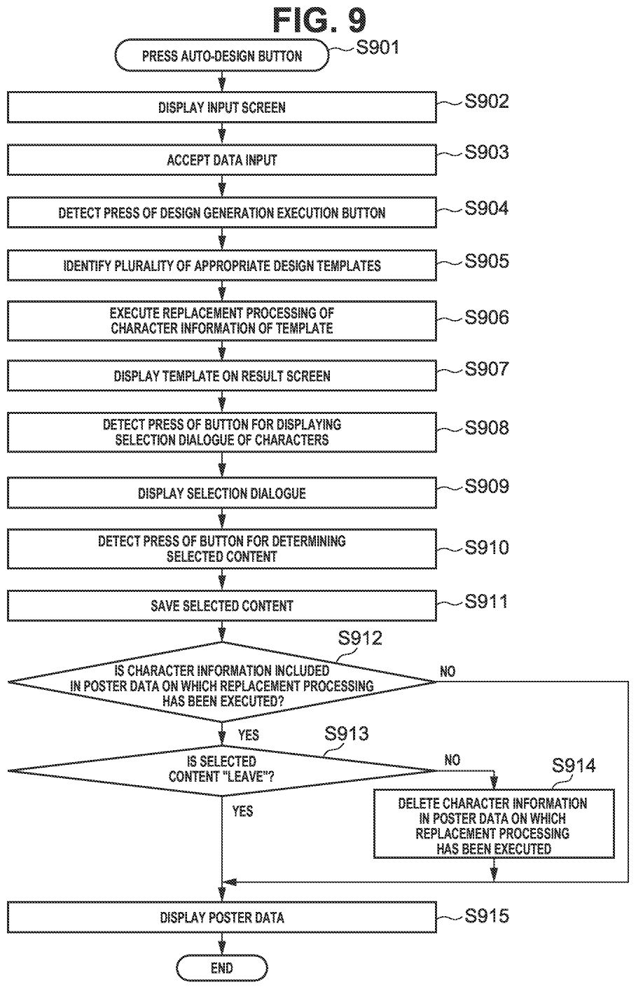

FIG. 9 is a flowchart illustrating the processing for executing the auto-design function. The processing illustrated in the flowchart in FIG. 9 is started when an auto-design button 1502, described below, in FIG. 15 is pressed in step S901. All or a part of the processing in the flowchart may be executed by the above-described external server.

In step S902, the poster production application 202 displays the input screen 300 in FIG. 3 which includes at least the title character information input part 301, the subtitle character information input part 302, the message character information input part 303, and the design generation execution button 304.

In step S903, the poster production application 202 accepts input of data to at least one of the input parts including the title character information input part 301, the subtitle character information input part 302, and the message character information input part 303 of the input screen 300.

In step S904, the poster production application 202 detects a press of the design generation execution button 304 illustrated in FIG. 3.

In step S905, the poster production application 202 compares the number of characters of content input to each of the title character information input part 301, the subtitle character information input part 302, and the message character information input part 303 of the input screen 300 with the number of characters of each of a title, a subtitle, and a message of a predetermined design template 501. Then, the poster production application 202 identifies a plurality of design templates 501 whose numbers of characters are little different from the number of characters of the input content as the appropriate design templates 501.

In step S906, the poster production application 202 executes replacement processing (i.e., character information replacement processing) to replace title character information, subtitle character information, and message character information previously registered in each of the identified design templates 501 with the pieces of input information the user has input to the title character information input part 301, the subtitle character information input part 302, and the message character information input part 303 of the input screen 300.

In step S907, the poster production application 202 sorts the design templates 501 into display order based on the display priority of the design templates 501. Specifically, for example, the poster production application 202 preferentially displays a design template 501 whose number of characters of each item is little different from the number of characters of each item input to the input screen 300, in the poster data display area 401. In step S907, one piece or a plurality of pieces of poster data 402 is displayed in the poster data display area 401 in a state where the character information 505 is included. In other words, the poster data 402 illustrated in FIG. 4 is displayed therein.

In step S908, the poster production application 202 detects that operation for displaying a selection dialogue (i.e., a screen or a notification) illustrated in FIG. 6 is accepted. For example, the poster production application 202 detects that the option setting button 405 in FIG. 4 is pressed.

In step S909, the poster production application 202 displays the dialogue illustrated in FIG. 6 which includes the toggle button 601, the OK button 602, and the close button 603.

In step S910, the poster production application 202 detects that the OK button 602 is pressed.

In step S911, the poster production application 202 saves content selected with the toggle button 601 when the OK button 602 is pressed in step S910 in the memory 104. In other words, the poster production application 202 saves information which indicates which of the options is selected from the options “LEAVE” and “DELETE” in FIG. 6.

In step S912, the poster production application 202 determines whether the above-described character information 505 is included in the poster data 402 on which the character information replacement processing has been executed in step S906. In a case where the poster production application 202 determines that the character information 505 is included (YES in step S912), the processing proceeds to step S913. In a case where the poster production application 202 determines that the character information 505 is not included (NO in step S912), the processing proceeds to step S915.

In step S913, the poster production application 202 determines whether the information saved in step S911, i.e., the content selected with the toggle button 601, is the option “LEAVE” or the option “DELETE”. In a case where the poster production application 202 determines that the saved information indicates the option “LEAVE” (YES in step S913), the processing proceeds to step S915. In a case where the poster production application 202 determines that the saved information indicates the option “DELETE” (NO in step S913), the processing proceeds to step S914. In a case where the saved information indicates the option “LEAVE”, the poster production application 202 executes the processing for not deleting the character information 505 included in the poster data 402 on which the character information replacement processing has been executed in step S906.

In step S914, the poster production application 202 executes the processing for deleting the character information 505 included in the poster data 402 on which the character information replacement processing has been executed in step S906.

In step S915, the poster production application 202 displays one piece or a plurality of pieces of automatically-generated poster data 402 on the poster data display area 401, and ends the processing in the flowchart in FIG. 9. Specifically, in a case where the user selects the option “LEAVE” and presses the OK button 602 in the dialogue illustrated in FIG. 6, the poster data 402 is displayed in a state where the character information 505 is included as illustrated in FIG. 4. On the other hand, in a case where the user selects the option “DELETE” and presses the OK button 602 in the dialogue illustrated in FIG. 6, the poster data 402 is displayed in a state where the character information 505 is deleted therefrom as illustrated in FIG. 7.

Further, in a case where the poster production application 202 detects that the operation for displaying the selection dialogue in FIG. 6 is accepted again, which is the processing in step S910, after the above-described processing of the flowchart is ended, the processing in steps S911 to S915 is executed again. For example, in a case where the option “DELETE” is selected in the selection dialogue in FIG. 6 and the poster data 402 is displayed in a state where the character information 505 is deleted therefrom as illustrated in FIG. 7, and if the user presses the option setting button 405 in FIG. 7 to display the selection dialogue in FIG. 6 again and selects the option “LEAVE”, the poster data 402 is displayed in a state where the character information 505 is included as illustrated in FIG. 4.

When a print button 1508 in FIG. 15 described below is pressed, the poster production application 202 executes processing for printing a poster (image) based on poster data 1504 currently displayed on the screen. In the processing, first, the poster production application 202 transmits an image edited by the poster production application 202 and an instruction for executing rendering of a preview to a rendering server via the Internet. The rendering server may be a server the same as or different from the server that provides (transmits) the poster production application 202 to the information processing apparatus 100. The poster production application 202 further activates an application different from the poster production application 202, i.e., a printing application for transmitting print data to a printing apparatus connected to the information processing apparatus 100. The printing application is transmitted from a server different from the server that provides (transmits) the poster production application 202 to the information processing apparatus 100 and is acquired by the information processing apparatus 100. Thereafter, the poster production application 202 acquires a preview image, which has been generated by the rendering server executing preview rendering on the image edited by the poster production application 202, from the rendering server, and provides the acquired preview image to the printing application. At this time, the printing application may acquire the preview image without using the poster production application 202. Then, the printing application executes preview display by using the preview image. When a press of the print button 1508 performed by the user is accepted, the printing application transmits an instruction for executing main rendering to the rendering server. Then, the printing application acquires print data generated by executing the main rendering of the image edited by the poster production application 202, and transmits the print data to the printing apparatus. Through the above-described processing, a poster is printed by the printing apparatus connected to the information processing apparatus 100 based on the poster data.

In the above-described exemplary embodiment, the poster production application 202 can accept a display instruction of a dialogue (e.g., the dialogue illustrated in FIG. 6) which prompts the user to select either to delete the character information 505 from the poster data 402 or to leave and display the character information 505 in the poster data 402 after the poster data 402 automatically generated by accepting the execution instruction of the auto-design function is displayed on the display unit 105. Then, in a case where the display instruction of the dialogue is accepted, the poster production application 202 displays a dialogue, such as the dialogue illustrated in FIG. 6. Then, in a case where the instruction for deleting the character information 505 from the poster data 402 is input by the user and accepted on the displayed dialogue, the poster production application 202 generates the poster data 402 from which the character information 505 is deleted, and displays the poster data 402 in the poster data display area 401. Thus, the poster data 402 on which the character information 505, which is previously registered in the predetermined design template 501 and is less relevant to the information input by the user, is not displayed is provided to the user. Thus, the user can easily recognize the image of the poster once completed.

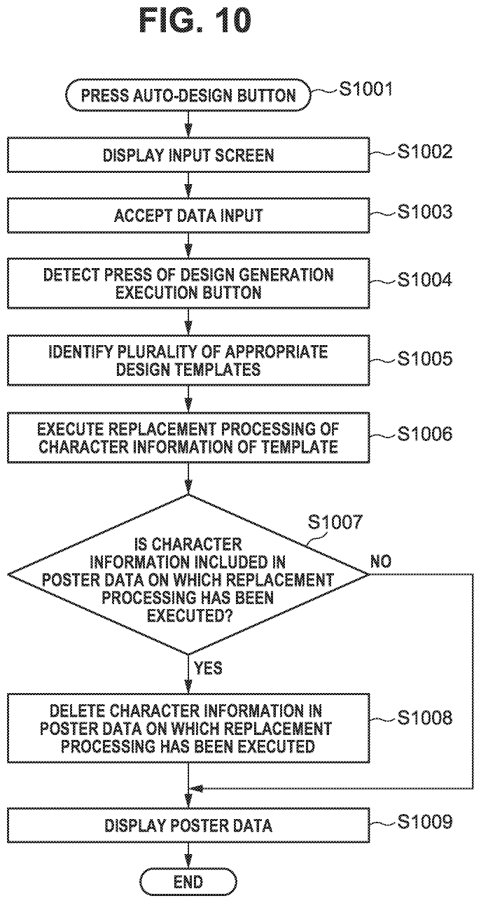

In the first exemplary embodiment, after the poster data 402 automatically generated based on the acceptance of the execution instruction of the auto-design function is displayed on the screen, the poster production application 202 displays the dialogue when the display instruction of the dialogue which prompts the user to select whether to delete the character information 505 is accepted. Then, the character information 505 is deleted when an instruction for deleting the character information 505 from the user is accepted. However, in a second exemplary embodiment, in a case where the character information 505 is included in the poster data 402 which is automatically generated based on the acceptance of the execution instruction of the auto-design function, the poster production application 202 deletes the character information 505 from the poster data 402 before displaying the poster data 402 on the screen, so that the poster data 402 is displayed on the screen in a state where the character information 505 is deleted therefrom. According to the present exemplary embodiment, in a case where the character information 505 is included in the poster data 402 automatically generated, the poster data 402 is displayed in the poster data display area 401 after the deletion processing is executed thereon. Thus, it is not necessary to display the dialogue as illustrated in FIG. 6. In other words, the option setting button 405 does not have to be included in the result screen 400 in FIG. 4. A flowchart illustrating processing for executing the auto-design function according to the present exemplary embodiment is illustrated in FIG. 10. The processing illustrated in the flowchart in FIG. 10 is started when the auto-design button 1502, described below, in FIG. 15 is pressed in step S1001.

Processes in steps S1002 to S1006, S1007, S1008, and S1009 are similar to the processes in steps S902 to S906, S912, S914, and S915. Therefore, descriptions thereof are omitted.

In the present exemplary embodiment, in a case where the character information 505 is included in the poster data 402 automatically generated, the poster data 402 is displayed in the poster data display area 401 after the deletion processing is executed thereon. Thus, the user can easily recognize the image of the poster once completed.

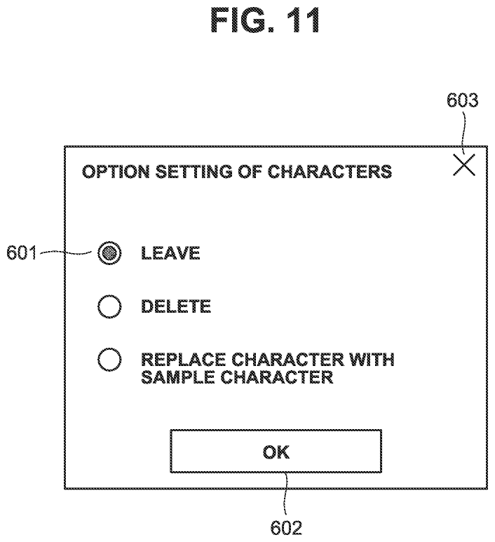

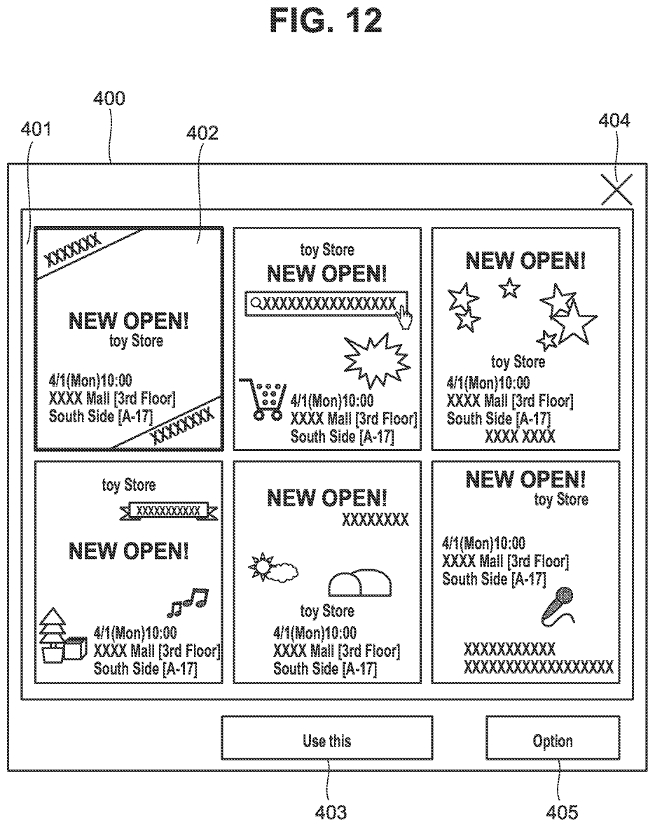

In the first exemplary embodiment, options “LEAVE” and “DELETE” are provided as the options in the dialogue illustrated in FIG. 6. In a third exemplary embodiment, as the options in the dialogue to be displayed on the display unit 105 when the option setting button 405 in FIG. 4 is pressed, an option “REPLACE CHARACTER WITH SAMPLE CHARACTER” is provided in addition the options “LEAVE” and “DELETE”. FIG. 11 is a diagram illustrating an example of a dialogue which includes the option “REPLACE CHARACTER WITH SAMPLE CHARACTER”. When the user selects the option with the toggle button 601 and presses the OK button 602, the poster data 402 is displayed in the poster data display area 401 in a state where the character information 505 registered in the predetermined design template 501 is replaced with predetermined sample characters, such as a character string or a symbol, as illustrated in FIG. 12.

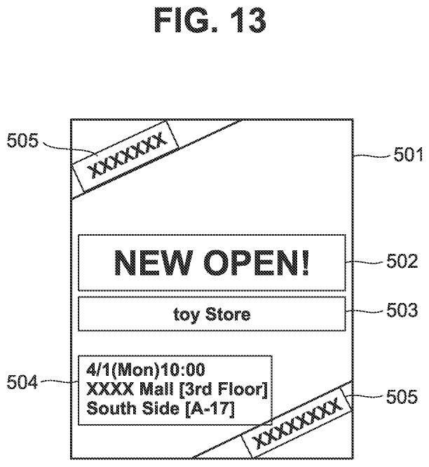

FIG. 13 illustrates the poster data 402 in a state where the character information 505 registered in a predetermined design template 501 is replaced with sample characters. The character information 505 is replaced with, for example, consecutive specific characters. For example, the character information 505 is replaced with sample characters “XXXXXXX”. Further, the character information 505 may be replaced with sample characters having the same number of characters as the number of characters in the character information 505. For example, when the character information 505 has three characters, the number of characters of the sample characters may be also three. Further, predetermined sample characters determined in advance may be used depending on the number of characters in the character information 505. For example, “NEW” may be predetermined as the sample characters to be used when the number of characters in the character information 505 is three.

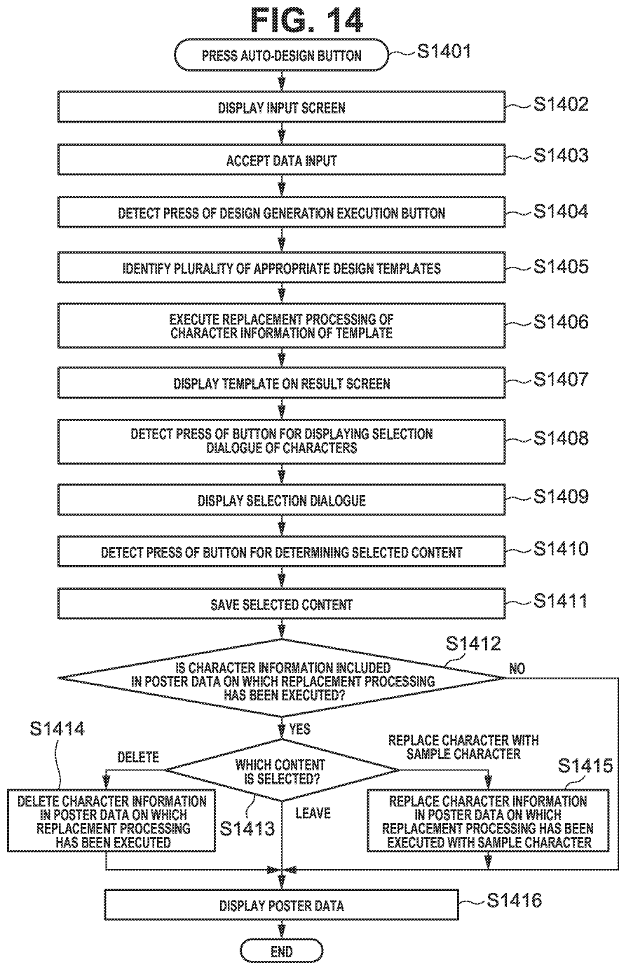

FIG. 14 is a flowchart illustrating processing for executing the auto-design function according to the present exemplary embodiment. The processing illustrated in the flowchart in FIG. 14 is started when the auto-design button 1502, described below, in FIG. 15 is pressed in step S1401.

Processes in steps S1402 to S1414 and S1416 are similar to the processes in steps S902 to S914 and S915. Therefore, descriptions thereof are omitted.

In step S1415, with respect to the automatically-generated poster data 402, on which the replacement processing of the character information has been executed in step S1406, the poster production application 202 executes replacement processing of replacing the character information 505 included in the poster data 402 with sample characters.

In the above-described exemplary embodiment, after the poster data 402 automatically generated based on the acceptance of the execution instruction of the auto-design function is displayed on the display unit 105, the poster production application 202 can accept a display instruction of a dialogue (e.g., the dialogue illustrated in FIG. 11) which prompts the user to select whether to delete the character information 505 from the poster data 402, replace the character information 505 with sample characters, or leave and display the character information 505 in the poster data 402. Then, in a case where the display instruction of the dialogue is accepted, the poster production application 202 displays a dialogue such as the dialogue illustrated in FIG. 6. Then, in a case where the instruction for replacing the character information 505 in the poster data 402 with the sample characters input by the user is accepted via the displayed dialogue, the poster production application 202 generates the poster data 402 in which the character information 505 is replaced with the sample characters, and displays the poster data 402 in the poster data display area 401. Thus, the poster data 402 in which the character information 505, which is information previously registered in the predetermined design template 501 and less relevant to the information input by the user, is replaced with the sample characters is provided to the user. Therefore, the user can easily recognize the image of the poster once completed.

Further, in the present exemplary embodiment, the sample characters displayed in the poster data 402 displayed in and selected from the poster data display area 401 may be editable. In other words, the user can edit the character information 505 replaced with the sample characters to different characters.

Further, the sample characters described in the present exemplary embodiment may be applied to the above-described second exemplary embodiment. In other words, in a case where the character information 505 is included in the poster data 402 automatically generated based on the acceptance of the execution instruction of the auto-design function, the poster production application 202 may execute the processing for replacing the character information 505 included in the poster data 402 with sample characters before displaying the poster data 402 on the screen, so that the poster data 402 in which the character information 505 is replaced with the sample characters is displayed on the screen.

In each of the first to third exemplary embodiments, in a case where an operation for inserting a text box to newly add characters is performed when the poster data 402 displayed in and selected from the poster data display area 401 is to be edited, default characters using a format of the character information 505 may be displayed at a position where the character information 505 is located. Further, in a case where characters are newly input to the poster data 402 displayed in and selected from the poster data display area 401, the input characters may be displayed at the position where the character information 505 is located using the format of the character information 505. The poster production application 202 implements the processing according to a fourth exemplary embodiment by saving position information and format setting information about the character information 505 when the processing for deleting the character information 505 is executed in the first exemplary embodiment.

FIG. 15 is a diagram illustrating an example of an edit screen for editing the poster data 402. For example, the edit screen 1500 in FIG. 15 includes a create new poster button 1501, the auto-design button 1502, a poster edit area 1503, the poster data 1504, an add text button 1505, an add figure button 1506, a format setting area 1507, and the print button 1508.

New poster data can be created by the user pressing the create new poster button 1501.

The poster production application 202 displays the input screen 300 when the auto-design button 1502 is pressed.

The poster production application 202 displays the poster data 1504 on the poster edit area 1503.

Poster data that is being edited is displayed as the poster data 1504. For example, in a case where the user selects predetermined poster data 402 and presses the design determination button 403 on the result screen 400, the selected poster data 402 is displayed as the poster data 1504.

In a case where the design determination button 403 is pressed in a state where the poster data 402 from which the character information 505 is deleted is selected from the poster data display area 401, the poster production application 202 displays the poster data 402 as the poster data 1504 in the poster edit area 1503.

In a case where a press of any position in the poster data 1504 is detected in a state where the add text button 1505 is selected, the poster production application 202 displays a text box with the pressed position as a starting position. The text box may be blank, or may have default characters. Herein, “Enter text.” is displayed as an example of the default characters. A format of the character information 505 previously registered in the design template 501 is applied to the default characters.

The poster production application 202 can add a figure when a press of any position on the poster data 1504 is detected in a state where the add figure button 1506 is selected.

The format setting area 1507 is an area where a general format, such as a font, a font size, and a character color, can be set to, and the set format is applied to the character information in the selected state in the poster data 1504.

The poster production application 202 executes printing processing of the poster data 1504 when the print button 1508 is pressed. In other words, the poster production application 202 instructs a predetermined printing apparatus to execute printing of the poster data 1504.

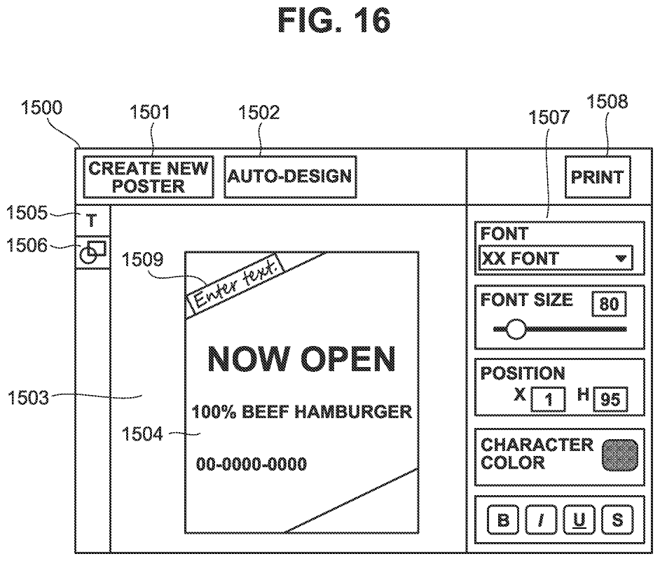

FIG. 16 is a diagram illustrating an example of the edit screen 1500 which includes a text box 1509. The text box 1509 has default characters that user the format of the character information 505 previously registered in a predetermined design template 501. The text box 1509 is character information newly added on the edit screen 1500. As described above, in the case where a press of any position in the poster data 1504 is detected in a state where the add text button 1505 is selected, the poster production application 202 displays a text box with the pressed position as the starting position. However, if the character information 505 has been deleted from the automatically-generated poster data 402, a display position of the text box is not limited to the pressed position in the poster data 1504, and the text box is displayed at a position where the character information 505 has been displayed. Further, on the newly added text box 1509, operation to change a position and a size of the text box 1509 may be performed in a similar way as operations on the other text objects.

With the above-described configuration, in a case where the user has to add the character information, the user can create a poster with reference to the position and the format setting of the character information in a predetermined design template 501.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2022-160960, filed Oct. 5, 2022, which is hereby incorporated by reference herein in its entirety.

What is claimed is:

1. A non-transitory computer-readable storage medium that stores a program for causing a computer to execute a control method of an information processing apparatus, the method comprising:
managing template data for content data to be generated;
accepting an input of information with respect to the content data;
replacing information included in the template data with the information accepted; and
generating the content data based on the information accepted,
wherein, in a case where the template data includes information that is not replaced, the content data in a state where the information that is not replaced is not displayed is generated.

2. The storage medium according to claim 1, further storing a program for causing the computer to execute, in a case where the template data includes the information that is not replaced, displaying a selection screen for prompting a user to select processing with respect to the information that is not replaced.

3. The storage medium according to claim 2,
wherein the processing with respect to the information that is not replaced is any one of processing for displaying the content data in a state where the information that is not replaced is displayed and processing for displaying the content data in a state where the information that is not replaced is not displayed, and
wherein a screen for prompting a user to select any one of the processing is displayed in the displaying the selection screen.

4. The storage medium according to claim 2,
wherein the processing with respect to the information that is not replaced is any one of processing for displaying the content data in a state where the information that is not replaced is displayed, processing for displaying the content data in the state where the information that is not replaced is not displayed, and processing for displaying the content data in a state where the information that is not replaced is replaced with a predetermined character string, and
wherein a screen for prompting the user to select any one of the processing is displayed in the displaying the selection screen.

5. The storage medium according to claim 1, wherein the content data in the state where the information that is not replaced is not displayed is content data in a state where processing for deleting or hiding the information that is not replaced or processing for displaying a predetermined character string in place of the information that is not replaced has been executed.

6. The storage medium according to claim 2, wherein, in a case where an editing operation for inputting characters is accepted with respect to the content data in a state where the information that is not replaced is not displayed, processing corresponding to the editing operation is executed based on position information and format setting information about the information that is not replaced.

7. The storage medium according to claim 6, wherein, in a case where input of characters is accepted as the editing operation with respect to the content data, the processing corresponding to the editing operation is processing for inputting the characters to a position of the information that is not replaced in a format of the information that is not replaced.

8. The storage medium according to claim 6, wherein, in a case where an insertion operation of a text box is accepted as the editing operation with respect to the content data, the processing corresponding to the editing operation is processing for displaying a phrase which prompts the user to input characters to a position of the information that is not replaced in a format of the information that is not replaced.

9. The storage medium according to claim 2, further storing a program for causing the computer to execute displaying the content data generated.

10. The storage medium according to claim 9,
wherein, in a case where processing for displaying the content data in a state where the information that is not replaced is displayed is selected in the displaying the selection screen, the content data in the state where the information that is not replaced is displayed is displayed in the displaying the content data, and
wherein, in a case where processing for displaying the content data in the state where the information that is not replaced is not displayed is selected in the displaying the selection screen, the content data in the state where the information that is not replaced is not displayed is displayed in the displaying the content data.

11. The storage medium according to claim 9,
wherein, in a case where processing for displaying the content data in a state where the information that is not replaced is displayed is selected in the displaying the selection screen, the content data in the state where the information that is not replaced is displayed is displayed in the displaying the content data,
wherein, in a case where processing for displaying the content data in the state where the information that is not replaced is not displayed is selected in the displaying the selection screen, the content data in the state where the information that is not replaced is not displayed is displayed in the displaying the content data, and
wherein, in a case where processing for displaying the content data in a state where the information that is not replaced is replaced with a predetermined character string is selected in the displaying the selection screen, the content data in the state where the information that is not replaced is replaced with the predetermined character string is displayed in the displaying the content data.

12. The storage medium according to claim 2, further storing a program for causing the computer to execute displaying the content data generated.

13. The storage medium according to claim 1, wherein the content data is poster data.

14. The storage medium according to claim 1, wherein, in the case where the template data includes the information that is not replaced because the information is not input although the information is acceptable, the content data in the state where the information that is not replaced is not displayed is generated.

15. The storage medium according to claim 1, wherein, in the case where the template data includes the information that is not replaced because the information is not acceptable and is not input, the content data in the state where the information that is not replaced is not displayed is generated.

16. A control method of an information processing apparatus comprising:
managing template data for content data to be generated;
accepting an input of information with respect to the content data;
replacing information included in the template data with the information accepted; and
generating the content data based on the information accepted,
wherein, in a case where the template data includes information that is not replaced, the content data in a state where the information that is not replaced is not displayed is generated.

17. An information processing apparatus comprising:
at least one processor configured to function as:
a management unit configured to manage template data for content data to be generated;
an acceptance unit configured to accept an input of information with respect to the content data;
a replacement unit configured to replace information included in the template data with the information accepted by the acceptance unit; and
a generation unit configured to generate the content data based on the information accepted by the acceptance unit,
wherein, in a case where the template data includes information that is not replaced by the replacement unit, the content data in a state where the information that is not replaced is not displayed is generated by the generation unit.
